(19) United States
(12) Patent Application Publication
(10) Pub. No.: US 2016/0053678 A1
(43) Pub. Date: Feb. 25, 2016

(54) WASTE HEAT RECOVERY SYSTEM

(71) Applicant: DANA LIMITED, Maumee, OH (US)

(72) Inventors: DONALD J. REMBOSKI, ANN ARBOR, MI (US); MARK R.J. VERSTEYHE, OOSTKAMP (BE)

(73) Assignee: DANA LIMITED, MAUMEE, OH (US)

(21) Appl. No.: 14/392,088

(22) PCT Filed: Mar. 20, 2014
(86) PCT No.: PCT/EP2014/055664

§ 371 Date: Sep. 24, 2015

Related U.S. Application Data
(60) Provisional application No. 61/804,849, filed on Mar. 25, 2013.

(51) Int. Cl. F02B 75/32; F01N 5/02; F01K 23/10; F02G 5/02

(52) U.S. Cl. CPC F02B 75/32; F02G 5/02; F01N 5/02; F01K 23/101

(57) ABSTRACT

A method and apparatus for controlling the mass flow rate of a positive displacement expander comprises pumping a working fluid to a heat exchanger to convert the fluid into a working vapor. At least a portion of the working vapor is stored in an accumulator connected to the heat exchanger. At least a portion of the working vapor stored in the accumulator is selectively released into a positive displacement expander via a pulse width modulated valve to increase the efficiency of the expander.

### RELATED APPLICATIONS

This application claims priority to and the benefit from U.S. Patent Application Ser. No. 61/804,849 filed on Mar. 25, 2013 which is incorporated by reference in its entirety.

### BACKGROUND FOR THE PRESENT DISCLOSURE

Conventional internal combustion engines (ICE) have a limited brake thermal efficiency (BTE). The energy produced during the combustion process can only partially be converted to useful work. Most of the fuel energy is being rejected as waste heat in the exhaust gases. It would be preferable to capture or recover some or all of the waste heat from the exhaust gases to improve the thermal efficiency of the engine, thus lowering fuel consumption and lowering CO2 emissions.

### SUMMARY OF THE PRESENT DISCLOSURE

A method and apparatus for controlling the mass flow rate of a positive displacement expander comprises pumping a working fluid to a heat exchanger to convert the fluid into a working vapor. At least a portion of the working vapor is stored in an accumulator connected to the heat exchanger. At least a portion of the working vapor stored in the accumulator is selectively released into a positive displacement expander via a pulse width modulated valve to increase the efficiency of the expander.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a schematic embodiment of one embodiment of a waste heat recuperation system;

FIG. 2A is a pressure verses volume chart for a waste heat recuperation system depicting under expansion losses;

FIG. 2B is a pressure verses volume chart for a waste heat recuperation system depicting over expansion losses; and

FIG. 3 is a schematic embodiment of another waste heat recuperation system.

### DETAILED DESCRIPTION OF THE EXEMPLARY EXAMPLES

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts of the present invention. Hence, specific dimensions, directions or other physical characteristics relating to the embodiments disclosed are not to be considered as limiting, unless expressly stated otherwise.

At least a portion of the waste heat energy from an internal combustion engine can be recovered by using a waste heat recuperation cycle. One example of such a cycle, to which the present invention is not limited, might be such as an Organic Rankine Cycle (ORC).

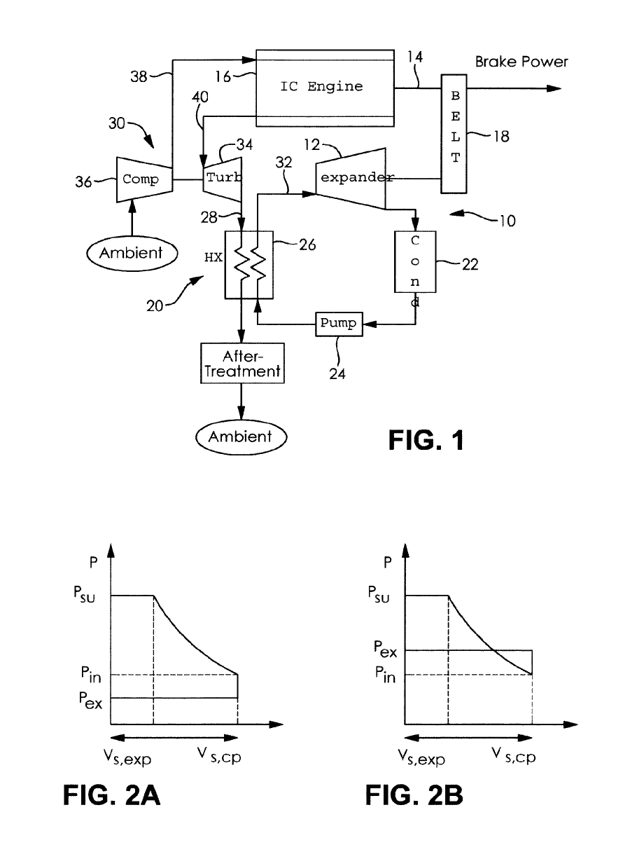

One embodiment of a Waste Heat Recovery (WHR) system 10 is depicted in FIG. 1. In FIG. 1, a positive displacement expander device 12 in the system 10 is directly mechanically coupled to a crankshaft 14 of an ICE 16 by a belt or gear box 18. Through this connection, the expander device 12 can supply additional torque and power to the crankshaft 14. By connecting the expander device 12 to the ICE 16, the overall thermal efficiency of the ICE 16 is improved, resulting in lower fuel consumption and lower CO2 emissions.

The WHR system includes a heat capturing circuit 20, the positive displacement expander device 12, a condenser 22, a feed pump 24 and a working fluid. The working fluid is a 2-phase fluid fitting the temperature range of the waste heat flows of the ICE or a mixture of such fluids. In most embodiments, the two phases for the fluid are liquid and gas or vapor.

The pump 24 moves the fluid from device to device as shown in FIG. 1. The condenser 22 condenses the fluid after it performs work in the expander device 12.

The heat capturing circuit 20 comprises a heat exchanger 26 and fluid lines leading into and away from the heat exchanger 26. A first line 28 brings fluid into the heat exchanger 26 from a turbocharger 30. The turbocharger 30 is connected to the ICE 16.

The first line 28 exits the heat exchanger 26 where it extends to an after-treatment. The after-treatment may be such as, but not limited to, a particle filter, a catalytic converter and/or a selective catalytic reduction device.

A second line 32 connects the positive displacement expander device 12, the condenser 22 and the pump 24 with the heat exchanger 26. While “a second line” and “a first line” are used above, and suggest each is an individual line, it can be appreciated that the multiple lines may comprise the “a first line” or the “a second line.”

In one embodiment, such as depicted in FIG. 1, the first line 28 in the heat exchanger 26 contains the waste heat flow from the ICE 16 via the turbocharger 30. Within the heat exchanger 26, the first line 28 can extend in any manner, which may include curvilinear. The first line 28 may also branch into multiple lines within the heat exchanger 26.

The second line 32 may also extend within the heat exchanger 26 in any manner, including curvilinear. The second line 32 may also branch into multiple lines within the heat exchanger 26.

Regardless of the size, shape or design of the first or second lines 28, 32 within the heat exchanger 26, it is preferred that they be adjacent, or in contact with one another, so that heat from the first line 28 gets exchanged to the second line 32 through convection, conduction and/or radiation.

The heat from the first line 28 turns the fluid in the second line 32 into a gas or vapor. The vapor travels through the second line 32 to the positive displacement expander device 12. The vapors are expanded in the device 12 to generate useful work that can be sent to the driveline.

As stated above, in the depicted embodiment, the heat exchanger 26 receives heated fluid in the first line 28 from the ICE via a turbocharger 30. The turbocharger 30 may be comprised of a turbine 34, which is connected to a compressor 36. The compressor 36 provides compressed air to the ICE 16, as shown via a line 38 connecting the compressor 36 to the ICE 16. The compressed air is denser than ambient air, which makes the ICE 16 more efficient when operating and more powerful as more air enters the combustion chambers. The ICE 16 in turn delivers heated exhaust gases to the turbine 34 via a line 40 connecting the ICE 16 and the turbine 34. The turbine 34 converts the heated exhaust gases into rotational energy which is then mechanically routed to the compressor 36. While a turbocharger 30 is discussed and depicted herein, it can be appreciated that the present waste heat recovery system 10 can operate in substantially the same way without it.

Usually the WHR system 10 will be designed to perform optimally at the normal operating point of the ICE 16 resulting in an optimal evaporation pressure and temperature in the heat exchanger 26 and an optimal mass flow for the working fluid according the normal engine speed and load. Optimization can be achieved by utilizing the appropriate size and type of the heat exchanger 26, condenser 22, pump 24 and expander device 12 for the operating conditions of the vehicle.

The ICE 16, however, can also operate under highly dynamic conditions, such as highly variable engine speeds and engine loads resulting in dynamic operating conditions for the WHR system 10. Under these conditions, the mass flow rate and/or evaporation pressure and temperature of the working fluid have to be controlled to maximize the power generated by the WHR system 10.

In the embodiment where the positive displacement expander device 12 is connected directly with a belt, or gear box 18 to the ICE 16, and more particularly, the ICE crankshaft 14, the expander device 12 and the engine speed have a fixed speed ratio. It can be appreciated that in this circumstance, the mass flow rate of the working fluid cannot be controlled independently from the engine speed for an expander device 12 with a fixed displacement. In this condition, a non-optimal evaporation pressure in the heat exchanger 26 occurs. It can be appreciated that if the fluid is not optimally evaporated in the heat exchanger 26, it will not perform the same work in the expander device 12, thus making the WHR system less efficient than it can be.

Continuing with this example, when a vehicle is driving at constant speed, and the slope of the road increases, the load on the ICE 16 also increases. An increased engine load results in a higher fuel consumption and so more thermal energy can be recovered in the exhaust gases. In order to optimize the waste heat recovery, the mass flow rate of the working fluid has to increase when operating the WHR system 10 at constant and optimal working conditions. As the ICE 16 and positive displacement expander device 12 are operating at constant speed, the mass flow rate cannot be altered over the expander device 12 resulting in an increase of the heat exchanger pressure. As the expander device 12 has a fixed displacement and expansion ratio, an increase of the expander device 12 inlet pressure will cause an increase of the under expansion losses and thus will lower the conversion efficiency of the WHR system 10, which can be appreciated by FIG. 2A. FIG. 2B shows the opposite—which is the situation where the fluid is over-expanded. This situation is also undesirable since it reduces the amount of work available to be executed from the fluid.

In FIGS. 2A and 2B, the following chart references are used, which are defined below:

Pex is the pressure at the exhaust of the working fluid, when a piston chamber is open to an outlet;

Pin is the pressure at the end of the expansion phase in the piston chamber;

Psu is the suction pressure, thus the pressure of the fluid that enters a piston chamber;

Vs, exp is the dead volume which cannot be used; and

Vs, cp is the usable volume that the piston will cover.

Similar rationale can be applied in the case of variable engine speed or other dynamic operation conditions of the ICE and WHR system. In order to maximize the conversion efficiency of the WHR system, the mass flow rate of the working fluid and/or the heat exchanger pressure has to be controlled independently of the engine speed.

The device and method described herein utilizes the structure depicted in FIG. 1 to overcome the shortcomings discussed above by controlling the thermal cyclic process of the positive displacement expander device 12 in the WHR system 10. More specifically, the mass flow rate of the positive displacement expander device 12 is controlled and the pressure level of the working fluid in the waste heat exchanger device 12 is controlled.

The positive displacement expander device 12 works by a vapor filling up a fixed volume, such as a piston chamber. The vapor is supplied by the heat exchanger 26, as described above. After the piston chamber volume is closed, the vapors are trapped and force a displacement, or expansion, of the piston. The piston, or pistons as the case may be, deliver work to an expander shaft attached to the piston making the expander shaft rotate.

As indicated above, the positive displacement expander device 12 is directly mechanically coupled to the ICE crankshaft 14 by the belt, or gear box, 18. It can therefore be appreciated that the torque generated by the expander device 12 is added to the ICE crankshaft 14, thus increasing the power output of the engine.

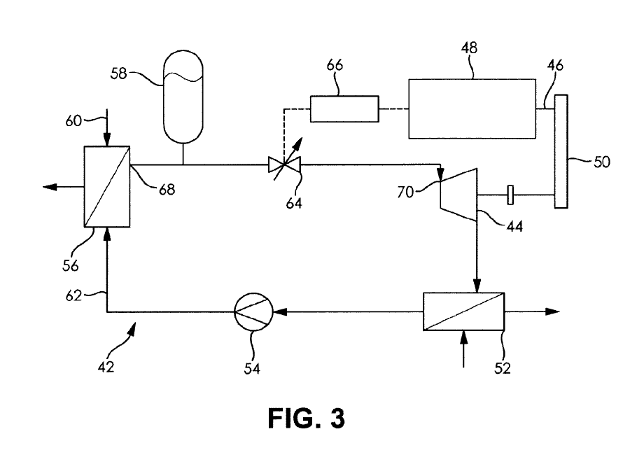

Another embodiment of a WHR system 42 is depicted in FIG. 3. In FIG. 3, a positive displacement expander device 44 in the system 42 is directly mechanically coupled to a crankshaft 46 of an ICE 48 by a belt or gear box 50. Through this connection, the expander device 44 can supply additional torque and power to the crankshaft 46. By connecting the expander device 44 to the ICE 48, the overall thermal efficiency of the ICE 48 is improved, resulting in lower fuel consumption and lower CO2 emissions.

While this specification will use the example of an expander device 44, it can be appreciated that the concepts discussed herein can also be adapted to compressors.

The WHR system includes the positive displacement expander device 44, a condenser 52, a feed pump 54 and a working fluid. The working fluid is a 2-phase fluid fitting the temperature range of the waste heat flows of the ICE or a mixture of such fluids. in most embodiments, the two phases for the fluid are liquid and gas or vapor.

The pump 54 moves the fluid from device to device as shown in FIG. 3. The condenser 52 condenses the fluid after it performs work in the expander device 44.

A heat exchanger 56 is provided and connected to the pump 54. A first line 60 brings heated fluid into the heat exchanger 56. The heated fluid can come from the ICE 48 or another mechanism, such as from a turbocharger (not shown), which may be connected to the ICE 48. The heat exchanger 56 may be connected to an after-treatment (not shown). The after-treatment may be such as, but not limited to, a particle filter, a catalytic converter and/or a selective catalytic reduction device.

A second line 62 connects the positive displacement expander device 44, the condenser 52 and the pump 54 with the heat exchanger 56. While “a second line” and “a first line” are used above, and suggest each is an individual line, it can be appreciated that the multiple lines may comprise the “a first line” or the “a second line.”

In one embodiment, such as depicted in FIG. 3, the first line 60 in the heat exchanger 26 contains the waste heat flow from the ICE 48. Within the heat exchanger 56, the first line 60 can extend in any manner, which may include curvilinear. The first line 60 may also branch into multiple lines within the heat exchanger 56.

The second line 62 may also extend within the heat exchanger 56 in any manner, including curvilinear. The second line 62 may also branch into multiple lines within the heat exchanger 56.

Regardless of the size, shape or design of the first or second lines 60, 62 within the heat exchanger 56, it is preferred that they be adjacent, or in contact with one another, so that heat from the first line 60 gets exchanged to the second line 62 through convection, conduction and/or radiation.

The heat from the first line 60 turns the fluid in the second line 62 into a gas or vapor. The vapor travels through the second line 62 where it can enter an accumulator 58. The accumulator 58 is a pressure storage reservoir in which the fluid can be held under pressure, such as by an external source.

The accumulator 58 enables the system 42 to cope with the extremes of demand on the system 42 using a less powerful pump and/or a fixed displacement expander to respond more quickly to a temporary demand, and to smooth out pulsations.

A pulse width modulator valve 64 is provided in the second fluid line 62. The valve 64 is designed to open and close for a modulated period of time. The valve 64 is connected to an engine controller 66.

The modulator valve 64 is preferred since it operates either fully open or fully closed. The modulator valve 64 transitions between fully open and fully closed relatively quickly so that fluid flowing through the valve 64 does not lose pressure as a result of the transition. Further, a modulator valve 64 only has two positions: open and closed. The valve 64 does not have intermediate positions that result in undesirable fluid pressure drops; it is preferred that any transition time between open and closed be as short as possible.

The modulation aspect of the valve 64 is used so that the ratio between the time opened and the time closed gives the needed flow control needed in the system 10. By way of one example of how the valve 64 can be modulated to give the needed flow control, if the flow has to be restricted, the opening of the valve 64 may be delayed. Alternatively, if additional flow is needed, the valve 64 can remain open for a longer period of time, and/or it can be opened several times during the piston chamber filling cycle.

Based on the foregoing, it can be appreciated that the time the valve 64 remains open (or closed) is a function of the speed of the expander 44. For example, with a piston type expander, which is generally described herein, the time period the valve 64 might be open or closed will generally be on the same order of magnitude as the piston chamber filling cycle.

In the depicted embodiment in FIG. 3 the valve 64 is shown downstream from the accumulator 58. Further, the depicted embodiment only shows one valve 64 in the second line 62. It can be appreciated that the valve 64 can be located in other parts of the second line 62 other than as shown and that additional valves can be used. Preferably, the valve 64 is located between a heat exchanger outlet 68 and an inlet 70 for the expander 44.

The valve 64, controller 66 and accumulator 58 work together to control the pressure in the heat exchanger 56 and the mass flow rate for the fixed displacement expander 44 that is directly mechanically connected to the ICE 48.

The valve 64 remains closed, for example, while the engine 48 and expander 44 are generally operating at constant working conditions. The valve 64 can open, however, when, for example, the engine load increases. At the same time, the controller 66 reduces the engine torque and fuel consumption. The accumulated pressure from the accumulator 58 flows through the valve 64 to the expander 44 to increase the expander pressure and increase the mass flow rate for the system 42. Thus, it can be appreciated that by opening the valve 64 as needed, the mass flow rate to the expander 44 and/or the heat exchanger 56 pressure can be controlled independently of the expander 44 speed.

In accordance with the provisions of the patent statutes, the present invention has been described in what is considered to represent its preferred embodiments. However, it should be noted that the invention can be practiced otherwise than as specifically illustrated and described without departing from its spirit or scope.

1-7. (canceled)

8. A method of controlling the mass flow rate of a positive displacement expander, comprising:
pumping a working fluid to a heat exchanger to convert said fluid into a working vapor;
storing at least a portion of said working vapor in an accumulator connected to said heat exchanger; and
selectively releasing at least a portion of said stored working vapor into a positive displacement expander via a pulse width modulated valve to increase the efficiency of said expander.

9. The method of claim 8, further comprising connecting said valve to an engine controller which is connected to an engine, said controller reducing the engine torque and fuel to said engine when said stored working vapor is released from said accumulator to said expander.

10. The method of claim 9, wherein said working vapor produces torque in said expander that is delivered to a crankshaft of said engine.

11. The method of claim 8, wherein working vapor from said expander is transferred to a condenser to convert it back to a liquid.

12. The method of claim 9, wherein the mass flow rate of the working vapor is controlled independently from the engine torque.

13. A waste heat recovery system, comprising:
a fixed displacement expander directly connected to an internal combustion engine to selectively provide supplemental torque to said engine via a working fluid in said expander;
a condenser connected to said expander to condense said working fluid from said expander;
a pump connected to said condenser for moving said working fluid from said condenser;
a heat exchange connected to said pump, said heat exchanger vaporizing said fluid;
an accumulator connected to said heat exchanger for storing at least a portion of said vaporized fluid; and
a pulse width modulated valve connected to said accumulator to selectively release said stored vaporized fluid to said fixed displacement expander.

14. The waste heat recovery system of claim 13, wherein a controller connects the valve with the engine.
